(19) United States
(12) Patent Application Publication
(10) Pub. No.: US 2019/0206148 A1
(43) Pub. Date: Jul. 4, 2019

(54) DATA EVALUATION SYSTEM AND METHOD FOR DATA EVALUATION IN AN AIRCRAFT

(71) Applicant: Airbus Operations GmbH, Hamburg (DE)

(72) Inventors: Torben Schröter, Hamburg (DE); Christian Schmid, Hamburg (DE); Markus Wirth, Hamburg (DE); Volker Hasbach, Hamburg (DE); Tibor Grützke, Hamburg (DE); Nikolas Kern, Hamburg (DE); Annika Geisemeyer, Hamburg (DE); Thomas Meyerhoff, Hamburg (DE); Michael Netzler, Hamburg (DE)

(21) Appl. No.: 16/220,197

(22) Filed: Dec. 14, 2018

(30) Foreign Application Priority Data
Dec. 20, 2017 (DE) 10 2017 223 409.1

(51) Int. Cl. G07C 5/00; G08G 5/00

(52) U.S. Cl. CPC G07C 5/008; G08G 5/0013

(57) ABSTRACT

A data evaluation system, in particular for data evaluation on interfaces on board an aircraft, includes a data processing server having a receiver device, a data processing processor and an external server interface, and includes multiple data readers, coupled to the data processing server via the receiver device, that each have a device processor and a data capture component connected to the device processor and are configured to forward data captured by the data capture component to the data processing server for conditioning.

### CROSS-REFERENCE TO RELATED APPLICATION

This application claims priority to German Patent Application 10 2017 223 409.1 filed Dec. 20, 2018, the entire disclosure of which is incorporated by reference herein.

### TECHNICAL FIELD

The disclosure herein relates to a data evaluation system, in particular for data evaluation on interfaces on board an aircraft, to an aircraft having a data evaluation system of this kind and to a method for data evaluation in an aircraft.

### BACKGROUND

At least some aircraft generations of this kind have monitoring of communication data between cabin components and hold components among themselves and with controllers. However, the monitored communication data are usually not kept permanently and are used just for present control purposes and local operating state indicators. In particular, these data are for the most part not evaluated or stored for post-processing. For older aircraft generations, analyses and evaluations of communication and operating data accumulating during the flight can thus be performed only to a very limited extent after a flight.

There is a fundamental need for solutions that can preserve accumulating communication and operating data in aircraft for evaluations and analyses subsequent to the current operating situation.

The document DE 10 2012 105 474 A1 discloses a system for the automatic analysis of aircraft system data having an aircraft system data capture module and a data analysis module. The document US 2012/0130701 A1 discloses a method for monitoring the operating state of a vehicle platform. The document WO 2009/095439 A2 discloses a method and a system for supplying power to aircraft cabin modules. The Airbus Technical Digest “FAST 29”, December 2001, pages 2 to 7, discloses a system for simplified analysis of maintenance and repairs for aircraft.

### SUMMARY

One of the objects of the disclosure herein is thus to find improved solutions for data collection, data storage and data evaluation on board an aircraft.

This and other objects are achieved by a data evaluation system, an aircraft and a method for data evaluation on board an aircraft having features disclosed herein.

According to a first aspect of the disclosure herein, a data evaluation system, in particular for data evaluation on interfaces on board an aircraft, comprises a data processing server having a receiver device, a data processing processor and an external server interface, and comprises multiple data readers, coupled to the data processing server via the receiver device, that each have a device processor and a data capture component connected to the device processor and are designed to forward data captured by the data capture component to the data processing server for conditioning.

According to a second aspect of the disclosure herein, an aircraft comprises at least one data evaluation system according to the first aspect of the disclosure herein.

According to a third aspect of the disclosure herein, a method for data evaluation on board an aircraft, in particular an aircraft according to the second aspect of the disclosure herein, comprises the steps of capturing data by data capture components of multiple data readers, forwarding the captured data to a data processing server coupled to the data readers via a receiver device, conditioning the data by a data processing processor of the data processing server, and exporting the conditioned data from the data processing server via an external server interface.

A basic concept of the disclosure herein is to bundle data collection devices as modular interfaces and/or sensors in a data evaluation network, which is installed on board an aircraft in order to monitor electrical signals on board the aircraft that are routed via data lines and power supply lines. Technical communication and operating data are intended to be tapped off in this case without modifications to the data and without substantial intervention in the operation of the affected monitored aircraft components, which means that the actual operating and communication state of all monitored components of the aircraft can be simulated realistically and in real time.

The installation is simple, fast and space-saving, which means that it is possible for existing aircraft to be refitted with reduced maintenance and fitting. The individual modular interfaces and sensors are individually adaptable and tailored to the needs of the customer or geared to the local circumstances on board the aircraft to be refitted. Furthermore, electrical interfaces can be brought into line with existing standards.

The evaluation of all monitored communication and operating data permits shortening of the turnaround time for the aircraft at the airport and can be used for the predictive planning of maintenance and repairs. Additionally, monitored and evaluated communication and operating data can allow flexible further development of existing services and functions. In this case, a use analysis for vehicle components on the basis of the communication and operating data can allow feedback into the development and optimisation process for coming product cycles and a significant improvement in aircraft components.

According to some embodiments of the data evaluation system according to the disclosure herein, the data capture components can have data probes, bus and line monitors, sensors or energy monitors.

According to some further embodiments of the data evaluation system according to the disclosure herein, the data capture components may be coupled to at least one data bus and at least one power supply line of the aircraft. In this case, in some embodiments, there may be provision for at least one of the data readers to have adapter interfaces that are each connected as an intermediate adapter between a cabin element on board an aircraft and a supply socket of the aircraft.

According to some further embodiments of the data evaluation system according to the disclosure herein, the data readers can have wired output ports and/or wireless transceivers coupled to the device processor.

According to some further embodiments of the data evaluation system according to the disclosure herein, the data processing server can further have a wireless communication module.

According to some further embodiments of the data evaluation system according to the disclosure herein, the data processing server can further have a data processing memory coupled to the data processing processor.

The above configurations and developments can be combined with one another arbitrarily where useful. Further possible configurations, developments and implementations of the disclosure herein also comprise not explicitly cited combinations of features of the disclosure herein that are described above or below with respect to the exemplary embodiments. In particular, a person skilled in the art will in this case also add single aspects as improvements or additions to the respective basic form of the disclosure herein.

### BRIEF DESCRIPTION OF THE DRAWINGS

The disclosure herein is explained in more detail below on the basis of the exemplary embodiments indicated in the schematic, example figures, in which:

FIG. 1 shows a schematic block diagram of a data evaluation system for a data evaluation of communication and operating data on board an aircraft according to an embodiment of the disclosure herein;

FIG. 2 shows schematic detailed views of different variants for interface modules for use in the data evaluation system of FIG. 1;

FIG. 3 shows an exemplary illustration of an aircraft having a data evaluation system according to a further embodiment of the disclosure herein; and

FIG. 4 shows a schematic illustration of steps of a method for data evaluation on board an aircraft according to a further embodiment of the disclosure herein.

The accompanying figures are intended to convey a further understanding of the embodiments of the disclosure herein. They illustrate embodiments and are used in conjunction with the description to explain principles and concepts of the disclosure herein. Other embodiments and many of the cited advantages are obtained in view of the drawings. The elements of the drawings are not necessarily shown to scale in relation to one another. Direction-indicating terminology such as “at the top”, “at the bottom”, “on the left”, “on the right”, “above”, “below”, “horizontally”, “vertically”, “at the front”, “at the rear” and similar indications are used merely for explanatory purposes and do not serve to limit the generality to specific configurations as shown in the figures.

Identical, functionally identical and identically acting elements, features and components are each provided with the same reference signs in the figures of the drawing—unless stated otherwise.

### DETAILED DESCRIPTION

Cabin monuments within the context of the disclosure herein comprise all fittings in aircraft passenger cabins that are provided for looking after the passengers and/or for use by the passengers. Such fittings in an aircraft passenger cabin, such as toilets or galleys, are also referred to as monuments and are supplied with water, air or the like at the applicable installation position via the supply lines that are present in the aircraft, or drain lines are used to transport away waste water and rubbish. By way of example, there are individual system lines as required for each of vacuum, wastewater, auxiliary cooling or drinking water. The functions of the cabin monuments are routed to the monuments via different electrical data and/or power supply lines.

An integrated cabin management system on board an aircraft is used for operating and monitoring different passenger and crew functions. These functions include, by way of example, a communication system for the cabin crew, the cabin lighting, fill level indicators for the water/wastewater tanks, regulation of the cabin temperature and further monitoring functions. The cabin management system is a centrally controlled system having multiple redundant servers, the number of which can be determined according to the size of the aircraft. These redundant cabin management servers process the signals from all of the peripherals, which include various sensors and components controlled by the integrated cabin management system. Between the peripherals and the cabin management servers, there are network connection nodes that convert the signals from and to the cabin management servers. As a simple example, the network connection nodes can perform analogue/digital conversion (ND conversion) and digital/analogue conversion (D/A conversion) of the signals.

The cabin management servers can communicate with the peripheral components via two types of data buses, for example: the data bus of the first type can be used to transmit information relating to the functions of the cabin crew. The data bus of the second type can be used to transmit information relating to passenger-related functions. Accordingly, there may also be two different types of network connection nodes provided that perform the conversion on the different data buses.

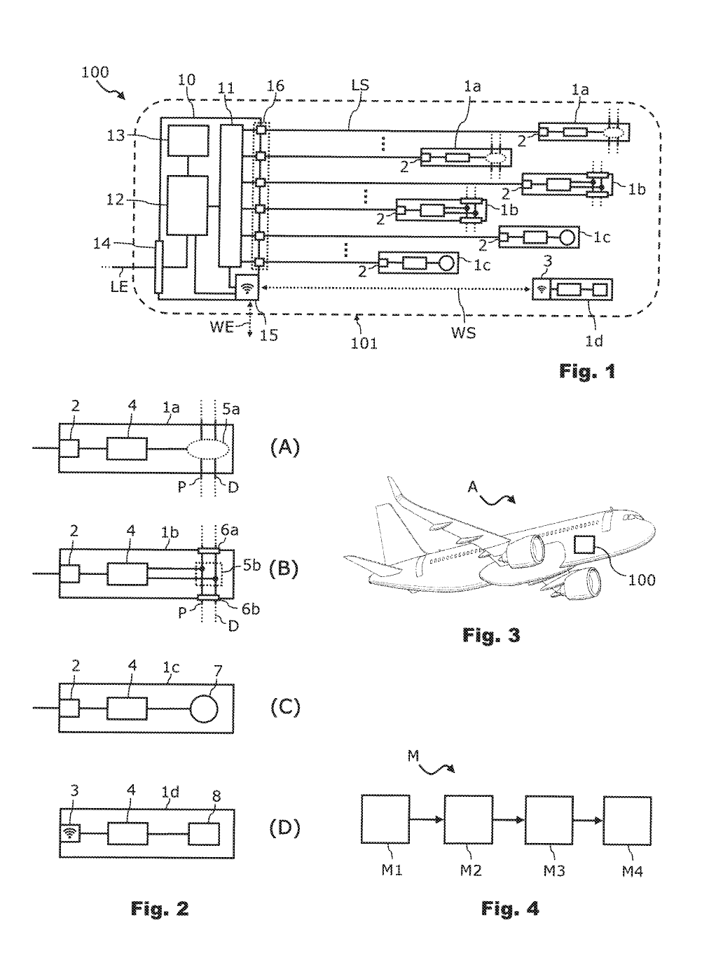

FIG. 1 shows a data evaluation system 100. The data evaluation system 100 can be used, by way of example, in the surroundings of or in an aircraft cabin 101 or a hold of an aircraft, such as, for example, in an aircraft A as depicted in FIG. 3, for example. The data evaluation system 100 is used for digitizing aircraft cabin and loading systems and components and modules implemented therein in order to enrich or generate stocks of data for a systematic application of statistical methods. In this case, data reading methods and networking methods are used that are used for FOMAX (“Flight Operation and Maintenance Exchanger”) or OSWP (“Open Software Platform”), for example.

The data evaluation system 100 fundamentally has a central data processing server 10 connected to one or more data readers 1a, 1b, 1c, 1d via a multiplicity of wired interfaces 16 and a wireless communication module 15. In this arrangement, the data readers 1a, 1 b, 1c, 1d can be distributed in the aircraft cabin 101 and/or the hold of an aircraft in order to be able to locally tap off data from connected devices, components, data buses, lines and the like. In principle, the number of interface modules 1a, 1b, 1c, 1d used is variable and can be matched to the respective aircraft design. Similarly, the number of interface modules per type is variable and can be matched to the respective aircraft design according to the devices, components, data buses, lines and the like to be monitored therein.

The data processing server 10 comprises a receiver device 11 coupled to the wired interfaces 16 and to the wireless communication module 15. The receiver device 11 is used to handle the communication with the data readers 1a, 1b, 1c, 1d connected to the data processing server 10 via wired output ports 2 or via wireless transceivers 3. The receiver device 11 forwards the data received from the data readers 1a, 1b, 1c, 1d to a data processing processor 12 coupled to the receiver device 11. The data processing processor 12 is designed to condition the data received from the data readers 1a, 1b, 1c, 1d. By way of example, the conditioned data can be buffer-stored in a data processing memory 13 until a wired data export LE is desired or possible on an external server interface 14 or wireless data transmission WE of conditioned data to be exported is possible by the communication module 15.

The data processing server 10 may be a network component installed permanently and firmly in the aircraft, for example. Alternatively, the data processing server 10 may also be a partially firmly installed and partially portable network component, for example using a docking station and a mobile part removable from the docking station. The data processing processor 12 in the data processing server 10 manages and controls the connected data readers 1a, 1b, 1c, 1d. Additionally, the data processing processor 12 checks the connectivity to external networks such as, for example, a WAN. The data processing processor 12 is further designed to check whether a portable local storage medium is connected to the external server interface 14 and is ready for wired data export LE. The data processing processor 12 executes an operating system with the applicable configuration parameters for controlling the connected data readers 1a, 1b, 1c, 1d. Also, the data processing processor 12 can execute a user interface application by which access to the data processing server 10 can be effected via user input devices and graphical display devices (not explicitly depicted).

There may additionally be provision for multiple data processing servers 10 to be installed in the data evaluation system 100. In this case, different data processing servers 10 may be responsible for physically or hierarchically isolated subgroups of the connected data readers 1a, 1b, 1c, 1d, or subgroups thereof isolated on a security basis, for example. Each of the data processing servers 10 can combine the received and conditioned data of the respectively connected data readers 1a, 1b, 1c, 1d in a common data pool, from which a further central data evaluation becomes possible.

FIG. 2 shows an example of four variants (A), (B), (C) and (D) for data readers 1a, 1b, 1c, 1d that can be used in the data evaluation system 100 and coupled to the data processing server 10. In this case, it should be clear that individual features of the four illustrative variants (A), (B), (C) and (D) are combinable among one another in order to arrive at further variants. By way of example, the wired output ports 2 of variants (A), (B) and (C) can each be replaced by wireless transceivers 3, as shown by way of example in variant (D). Also, for each of variants (A), (B), (C) and (D), it is possible for either a wired output port 2 or a wireless transceiver 3 to be provided in order to be able to make the data communication flexible depending on need and transmission capacities.

The data readers 1a, 1b, 1c, 1d basically have a device processor 4 that is coupled to a wired output port 2 (variants (A), (B) and (C)) and/or to a wireless transceiver 3 (variant (D)). Also, the device processor 4 is connected to one of various data capture components and receives captured data from same for conditioning and forwarding to the data processing server 10 via the wired output port 2 or the wireless transceiver 3.

In variant (A), the data capture component can have a data probe 5a inductively or capacitively coupled to at least one data bus D and at least one power supply line P. The data reader 1a of variant (A) can be configured as a switchbox for the connection between a cabin management server of an integrated cabin management system and a network connection node, for example. In this instance, all of the data communication via a proprietary data bus D between the cabin management server and the network connection node is captured without the data communication being significantly disturbed or altered. Also, the time profile of the supply of current to the network connection node can be logged by the cabin management server.

In variant (B), the data capture component can have a bus and line monitor 5b coupled to at least one data bus D and at least one power supply line P. The data reader 1b of variant (B) can be designed as an interface adapter for the connection of cabin elements such as, for example, seats or cabin monuments to the respective supply sockets on board the aircraft, for example. The cabin monument may be a sanitary installation module in a passenger cabin of an aircraft, for example, and the monitored components may in this case comprise a toilet, lighting, sensors and the like, for example. In this instance, the data reader 1b has two adapter interfaces 6a and 6b that are each connected as an intermediate adapter between the actual connecting interfaces between cabin element and supply socket. In this instance, all of the data communication via the data bus D between the cabin element and the aircraft is captured without the data communication being significantly disturbed or altered. Also, the time profile of the supply of current to the cabin element can be logged by the aircraft.

In variant (C), the data capture component can have a sensor denoted generally by reference sign 7. The data reader 1c of variant (C) can be used as a general sensor for any physical variable on board an aircraft that cannot be captured by the data readers 1a and 1b, for example. The data reader 1c may be a portable device that has an autonomous supply of power by storage batteries or batteries, for example.

In variant (D), the data capture component can have an energy monitor 8 designed to measure and capture electrical characteristic quantities from loads on board the aircraft. The data reader 1d of variant (D) can be used as a monitoring device for passive loads on board the aircraft that have no data communication of their own, for example.

The data readers 1a, 1b, 1c, 1d of FIG. 2 can be supplied with power by external energy sources of an aircraft, such as, for example, batteries, storage batteries, generators, fuel cells and the like. In this instance, the energy sources can comprise essential power supply sources, nonessential power supply sources, permanently energised power supply lines, non-permanently energised power supply lines and redundant power supply connections, for example.

Each of the data readers 1a, 1 b, 1c, 1d can have suitable screens and DC isolation circuits in order to leave the data communication and the supply of power on the monitored data buses and supply lines as undisturbed as possible. Additionally, each of the data readers 1a, 1b, 1c, 1d can have suitable protection circuits.

FIG. 4 shows a schematic depiction of a method M for data evaluation on board an aircraft, such as, for example, the aircraft A in FIG. 3. By way of example, the method M can be performed using a data evaluation system, such as, for example, the data evaluation system 100 in an aircraft as explained in connection with FIGS. 1 and 2.

The method M first of all comprises capturing data by data capture components of multiple data readers in a first step M1. In a second step M2, the captured data are forwarded to a data processing server that is coupled to the data readers via a receiver device. Then, in a third step M3, the data are conditioned by a data processing processor of the data processing server. Finally, in a fourth step M4, the conditioned data can be exported from the data processing server via an external server interface.

The method M can be used to collect accruing data on board an aircraft and to condition them for an evaluation. The conditioned data can then reveal patterns of use and operating cycles on board the aircraft, which can be useful for product further development or the design of new services on board an aircraft.

In the detailed description above, various features have been combined in one or more examples to improve the stringency of the depiction. However, it should be clear in this instance that the above description is of a merely illustrative but in no way limiting nature. It serves to cover all alternatives, modifications and equivalents of the various features and exemplary embodiments. Many other examples will be immediately and directly clear to a person skilled in the art on the basis of his knowledge in the art in view of the above description.

The exemplary embodiments have been selected and described in order to be able to portray the principles on which the disclosure herein is based and the opportunities for application of the principles in practice in the best possible way. As a result, persons skilled in the art can modify and use the disclosure herein and its various exemplary embodiments in optimum fashion for the intended purpose.

The subject matter disclosed herein can be implemented in software in combination with hardware and/or firmware. For example, the subject matter described herein can be implemented in software executed by a processor or processing unit. In one exemplary implementation, the subject matter described herein can be implemented using a computer readable medium having stored thereon computer executable instructions that when executed by a processor of a computer control the computer to perform steps. Exemplary computer readable mediums suitable for implementing the subject matter described herein include non-transitory devices, such as disk memory devices, chip memory devices, programmable logic devices, and application specific integrated circuits. In addition, a computer readable medium that implements the subject matter described herein can be located on a single device or computing platform or can be distributed across multiple devices or computing platforms.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A data evaluation system, comprising:
a data processing server having a receiver device, a data processing processor and an external server interface; and
multiple data readers, coupled to the data processing server via the receiver device, that each have a device processor and a data capture component connected to the device processor and are configured to forward data captured by the data capture component to the data processing server for conditioning.

2. The data evaluation system according to claim 1, wherein the data capture components have data probes, bus and line monitors, sensors or energy monitors.

3. The data evaluation system according to claim 1, wherein the data capture components are coupled to at least one data bus and at least one power supply line of the aircraft.

4. The data evaluation system according to claim 3, wherein at least one of the data readers has adapter interfaces that are each connected as an intermediate adapter between a cabin element on board an aircraft and a supply socket of the aircraft.

5. The data evaluation system according to claim 1, wherein the data readers have wired output ports and/or wireless transceivers coupled to the device processor.

6. The data evaluation system according to claim 1, wherein the data processing server further has a wireless communication module.

7. The data evaluation system according to one of claim 1, wherein the data processing server further has a data processing memory coupled to the data processing processor.

8. An aircraft having a data evaluation system according to claim 1.

9. A method for data evaluation in an aircraft, comprising:
capturing data by data capture components of multiple data readers;
forwarding the captured data to a data processing server coupled to the data readers via a receiver device;
conditioning the data by a data processing processor of the data processing server; and
exporting the conditioned data from the data processing server via an external server interface.
